(19) United States
(12) Patent Application Publication
(10) Pub. No.: US 2018/0176925 A1
(43) Pub. Date: Jun. 21, 2018

(54) COMMUNICATION METHOD AND SYSTEM

(71) Applicant: THALES, COURBEVOIE (FR)

(72) Inventors: Gilbert MULTEDO, GENNEVILLIERS CEDEX (FR); Catherine LAMY-BERGOT, GENNEVILLIERS CEDEX (FR); Jean-Luc ROGIER, GENNEVILLIERS CEDEX (FR)

(21) Appl. No.: 15/837,679

(22) Filed: Dec. 11, 2017

(30) Foreign Application Priority Data
Dec. 19, 2016 (FR) 1601800

(51) Int. Cl. H04W 72/08; H04W 72/04; H04W 72/10

(52) U.S. Cl. CPC H04W 72/085; H04W 72/048; H04W 72/10; H04W 72/0446; H04W 72/0453

(57) ABSTRACT

A system and a method for communication between at least one user in a high-frequency HF communication system comprising at least one transmission site and at least one reception site, the two sites being remote from one another by a distance D, comprises at least the following steps: scanning the signals or frequencies by using a wide band receiver, detecting whether there is a request to establish a communication link contained in the signals received on the receiver, if yes, then transmitting this link establishment request to the transmitting equipment item which will check whether it is possible to establish a link and, if it is, which will determine a possible configuration and establish a communication mode for the mobile user, if not, then returning to the step in which the signals received on the reception site of the system are scanned.

### CROSS-REFERENCE TO RELATED APPLICATIONS

This application claims priority to foreign French patent application No. FR 1601800, filed on Dec. 19, 2016, the disclosure of which is incorporated by reference in its entirety.

### FIELD OF THE INVENTION

The invention relates to a high-frequency HF band communication method and system, applicable to the infrastructure stations and to the mobile stations (naval, terrestrial, aeronautical) that are connected thereto. It relates to the establishment of links and the overall optimization of the communication resources on the HF media, media which prove to be particularly variable, because the conditions in ionospheric mode vary in particular depending on the solar cycle, the season, the time of the day. It also allows for the implementation of high speed wide band solutions which require a better link budget.

It applies to the field of high-frequency HF communications and can be used for narrow band and wide band uses.

The HF links in particular offer a beyond line of sight (BLOS) capacity which allows for communications to be carried out at long, even very long, range, without requiring recourse to a satellite or to the use of relay stations.

### BACKGROUND

The HF transmissions, notably when seeking to handle medium to long distances (1000-10 000 km class) generally rely on infrastructure stations or dedicated sites in which are deployed antennas of large size and of high gain and, specifically for the “transmission” part, high-power amplifiers (typically greater than 1 kW). The infrastructures links these days allow almost all of the globe to be reached with very low bit rates, for example 75 bits/s with an availability greater than 90%, and do so by using high-power amplifiers between 5 and 10 kW and high-gain antennas. An infrastructure station comprises two parts or geographic sites which are generally separated by at least several tens of kilometres to avoid the radio frequency pollution of the receivers by the high-power transmitters. A communication link, generally perfect and with low latency, links the two sites and allows a dual-site mode transceiver-type operation. The communication link used is, for example, a microwave beam, a dedicated link, etc. The links between the infrastructure station and a mobile (or another infrastructure station) are then established:

either in fixed frequency FF mode, the case in which the transmitter and the receiver have previously decided on the frequency that they would use, therefore in which the receiver listens to the frequency (monitors the frequency) to react when it detects a call,

or by automatic link establishment or ALE, a case for which several procedures exist, standardized or not. These procedures are based on hopping synchronously or asynchronously between the different frequencies of a pre-established plan. The receiver, which is monitoring this pre-established frequency plan, therefore hops in frequency by listening to the instantaneous frequency to react when it detects a call.

These infrastructure stations establish links either with other infrastructure sites, or with mobile users, for example a boat, a vehicle, an aircraft, etc., or semi-mobile users, for example a command station. The mobile or semi-mobile user is generally equipped with low- or medium-power transmitters, typically of the order of 20 to 500 W, and antennas whose dimensions depend on the size and the bulk of the platform or even the available space. This leads naturally to a link imbalance between an infrastructure site and a mobile user. Once the link is established, the associated equipment items (antenna, amplifier, radio, modem, etc.) are dedicated to the communication. An operator or a management system allows them to be configured in a mode of interest, for the waveform or forms of interest, and for the frequencies of interest, as a function of the scheduling provided for the operation of the system. This approach leads to a dimensioning of the equipment items as a function of the number of links to be monitored, and also of the antenna types, the directional antennas making it possible to have a high gain.

There is currently a need to offer optimized solutions in terms of cost/surface used/ease of deploying the system to address in particular the recurrent need for competitiveness. Also, there are efforts to improve the performance levels of the current systems to enhance the resilience of the HF links, often considered to be insufficiently reliable and not long enough to establish, but also to allow the implementation of high speed wide band solutions which require a better link budget.

The prior art describes two types of solutions. A first approach relies on the use of more powerful and more numerous resources and the second relies on the implementation of antenna processing in transmission and reception.

The first approach consists in increasing the power of the amplifiers in the existing installations. The latter are generally already very powerful with respect to what can currently be achieved. The maximum available power is of the order of 10 kW, the antennas are of the log-periodic type of a height greater than 10 m. The antenna arrays can be used in reception, which allows for an antenna gain in reception by beam forming. Increasing these power and dimension values presupposes significant investments, for gains which ultimately prove to be proportionately very low. For example, changing to 20 Kw only provides a gain of 3 dB.

In the second approach, the antenna gain is increased by using, for example, directional antennas. The increase in the directionality of the antennas leads to an increase in the number of processing chains to monitor all the directions of interest. This increase has a significant impact in terms of installation and maintenance cost. The use of directional antennas, such as rhombic, log-periodic antennas, naturally generates a dimensioning of the equipment as a function of the number of directions to be monitored (typically, a theoretical isotropic omnidirectional antenna allows all the directions to be monitored, whereas an antenna exhibiting a high gain is sectorially oriented and must therefore be oriented in the right direction, after this direction has been determined, or by default if the antenna monitors a sector, whether it is a transmission-mode or reception-mode antenna. In reception mode, it is also possible to consider the use of antenna arrays, in which each elementary antenna is typically omnidirectional and with low gain, but in which beam forming by computation can be applied to create a virtual directional antenna. Such a solution is typically employed in goniometry equipment.

Another way of approaching the problem is to define a greater meshing of the globe to reduce the distance to be covered. This involves establishing several stations (and therefore associated sites). Increasing the number of infrastructure stations allows the overall return from the network of stations to be improved, but poses the problem of the cost of these additional stations and of the feasibility of the installation thereof. In effect, it is necessary to have dedicated spaces, which can prove difficult in the open sea, for example, or far from the territory thereof.

Another solution consists in using a wide band reception antenna adapted to perform HF traffic listening and goniometry functions allowing for the detection of transmissions, with an improved antenna gain via beam forming. These solutions are not constrained in real time, in the same way as the communication process, in particular in ALE phase, can be. Because of this, the sequencings and the operations applied will generally differ: if the network is not formed in real time, the delayed processing time with beam-forming on direction of arrival is not impacted, although the ALE processing has a maximum latency allowed for the response.

Despite the results obtained by the systems known from the prior art, the latter do not make it possible to obtain the desired performance levels for HF communications, while reducing the costs of deployment of the solution.

The object of the present invention is to propose a method and a system which are based on a wide band processing in reception relying on an array of antennas and the application of beam forming, and on the management of the resources on the transmission site to optimize the use thereof and the quality of the links established, while observing the respective priorities of communication flows or establishment requests.

In the present invention, the concept of broadband is defined as being a listening band strictly greater than the instantaneous band of maximum possible modulated signals.

### SUMMARY OF THE INVENTION

The invention relates to a method for establishing a communication link for a mobile user in a high-frequency HF communication system comprising at least one transmission site and at least one reception site, the two sites being remote from one another by a distance D, characterized in that it comprises at least the following steps:

at the reception site, by using a wide band receiver, i.e., a listening band strictly greater than the instantaneous band of maximum possible modulated signals, scanning the signals or the frequencies, detecting whether there is a request to establish a communication link contained in the signals received on the receiver,

if request exists, then transmit this request to establish a communication link to transmitters and to a control module HUB which checks if it possible to establish a communication link and if so who determines a possible configuration and establishes a communication mode for the mobile user based on configuration information calculated by the transmission site,

if no request exists, then return to the scanning step of the received signals.

The method comprises the following steps,

scanning the frequencies of interest fᵢₙₜ for a given communication, and estimating the energy level received on the frequencies monitored by the wide band receiver,

if the energy value received on the wide band receiver corresponds to a fixed frequency FF or ALE request, then forming a beam for the communication, in the case where a link establishment request has been received before the expiry of a timer, checking whether the transmission site has resources for establishing the requested communication link and starting a communication mode, otherwise returning to the step of monitoring or scanning on the reception frequencies.

For a fixed frequency FF request, the call is carried out on one and the same frequency and for an ALE request, the call is carried out successively or in parallel on several frequencies of different values.

According to one embodiment, the method computes the direction of arrival of the signal and transmits this information to the transmission site to determine the transmission configuration available for a given configuration.

The method can comprise a step in which the computed configuration is compared with a set of existing configurations and, if a better configuration exists, then the HUB module transmits the new configuration parameters for the communication process or processes to the driven equipment items (amplifier, matrix, etc.).

The method analyses, for example, the content of the communication request and, based on the priority of the communication, it frees up resources used by a current communication to reassign them to this new communication.

On reception of a communication request, the method suspends a current communication to transmit a wait indication to the new communication.

The invention relates also to an HF communication system comprising at least one transmission site and one reception site, the two sites being separated by a distance D chosen to avoid the disturbances from the transmission site on the reception site, characterized in that:

the transmission site comprises at least several transmitters linked to a set of transmitting antennas and an HF control module,

the reception site comprises a wide band receiver and an HF control module,

said HF control modules at the transmission site and at the reception site being adapted to execute the steps of the method according to the invention.

### BRIEF DESCRIPTION OF THE DRAWING

Other features and advantages of the invention will become more apparent on reading the following detailed description given in an illustrative and nonlimiting manner, and which is given with reference to the attached drawings in which:

FIG. 1 schematically represents a global system example in which the invention can be used,

FIG. 2 is an example of architecture according to the invention,

FIG. 3 illustrates the steps of initialization of the different elements participating in the invention, and

FIG. 4 illustrates the steps implemented by the method according to the invention.

### DETAILED DESCRIPTION

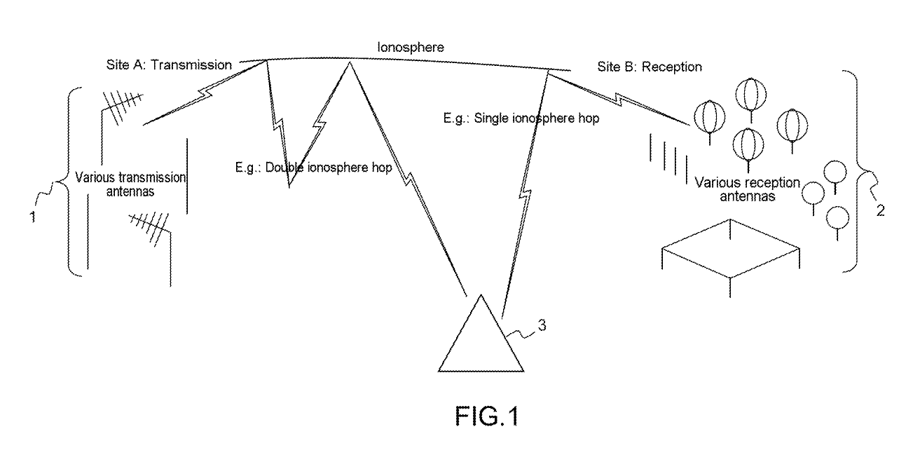

FIG. 1 is a global diagram illustrating the position of a transmission site 1 remote from a reception site 2 and a mobile user or ship 3 wanting to establish a communication. The transmission site and the reception site are positioned at a distance D chosen so as to avoid any radio frequency disturbance from one site on the other and the two sites communicate via a network of leased lines or LS, wide area network WAN, or microwave beam FH type.

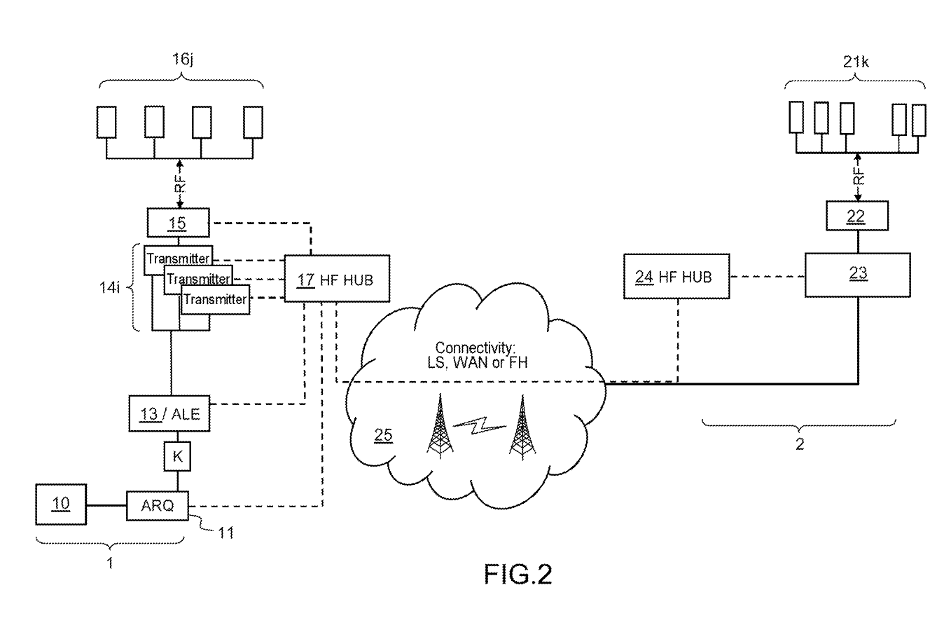

FIG. 2 illustrates an example of system architecture according to the invention comprising the transmission site 1 and the reception site 2.

The method allows all the frequencies of interest to be monitored by means of arrayed antennas and a wide band receiver, capable of forming beams for the parallel computation and processing of a number of links greater than the maximum number of links provided for the station.

The transmission site 1 comprises, for example, an operator station 10, linked with a module 11 adapted to manage the reliabilization of the links, a cryptography module 12 for the data to be transmitted. The encrypted data are transmitted to a modulator/demodulator or modem 13 having an output linked to several transmitters 14i linked to a switching matrix 15 of a set of n transmitting antennas 16j. The modem 13 performs the modulation functions for the traffic and the management of the ALE link. The transmission site also comprises an HF HUB control module 17. The control module is linked to the modem 13, to the transmitter, to the switching matrix 15 and optionally to the reliabilization module 11 to drive them according to its communication strategies, in particular according to communication establishment requests that it receives.

On the transmission side, a multicriterion process for optimizing the use of the resources, taking account of the capacities of the equipment items, of the quality of the links and of the priorities of the different flows, optimizes the choices of the resources for each link. The system manages, via the HUB control module, the resources in a way optimized as a function:

on the one hand of the capacity of the resources (for example a TX antenna operating only above 6 MHz will not be eligible for a transmission at fi=4.5 MHz; for example, a TX antenna not supporting 10 Kw not eligible for use with an unrestrainable 10 kW power amplifier; for example a directional antenna that cannot aim over the sector of the chosen communication will not be able to be selected, etc.), and

on the other hand, as a function of the operation priorities and quality of service QoS (in the sense of bit rate and quality requirements). Typically, when compromises have to be made and when only one communication is possible, it is the highest priority communication which will be favoured.

The reception site 2 comprises several wide band antennas 21k connected to a multiplexer 22 linked to a wide band receiver 23 and to an HF HUB control module 24.

The transmission site 1 and the reception site 2 communicate via a communication network 25. In particular, the two HUB control modules of these two sites communicate via this communication network to exchange the commands and the information necessary to the correct operation of the HUB function.

The implementation of the method according to the invention comprises an optional first phase of initialization of the system and a second phase of implementation.

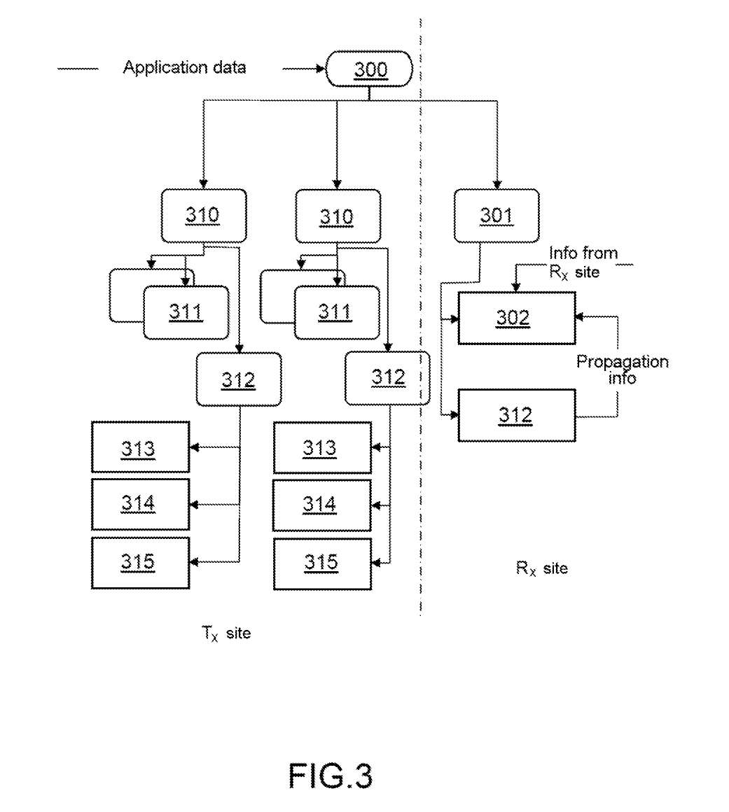

FIG. 3 is a block diagram of an example of steps for the initialization of the system and of the method according to the invention. The method knows the data of the mission or of the application, frequencies of interest, waveforms employed, keys, sectors of the different missions.

On the transmission side of the station, the method initiates the resource management process 301, for example by computing all the ΔT, 302, an available configuration for each possible direction, by taking account, for example, of the information from the reception site or else from data provided by an operator as a function of a targeted application. The value of the period ΔT is chosen, for example, as a function of the application. It can also perform propagation prediction computations for the different missions, 303, this being optional. A propagation computation resource notably makes it possible to refine the scope of the possibilities in terms of the passing frequencies, the power requirement, etc. Such information can be used for the computation of the possible configurations.

On the reception side, the method initializes the n antennas of the reception station in listening mode 310. The listening sensor launches as many monitoring processes as there are frequencies of interest which are allocated to it, 311. In parallel, it can also launch a channel analysis process and, from the results, compute a noise floor, 312, a computation of occupancy in the band of the reception antenna, 313, identify sources of interference or other communications received on the antenna, 314.

At the end of the initialization phase, information concerning the possible frequencies, the powers needed for an application or a mission, is available. In particular, there may be, for each mission, a default set of directions of arrival, of passing frequencies, of powers needed to establish a communication.

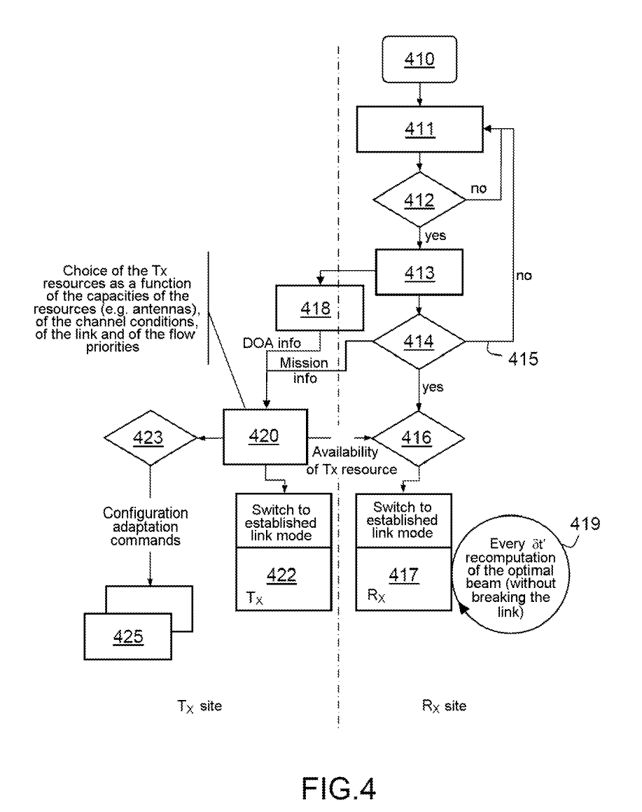

FIG. 4 illustrates an example of implementation of the method according to the invention.

The HUB module on the reception site side launches a process of monitoring a frequency of interest fᵢₙₜ, 410i. It performs, 411, a computation every δt of the correlation of the signals received on the n reception antennas in order to determine the energy received, 412. The value of δt is chosen as a function of the application. If energy is detected, i.e. the energy value is for example greater than a threshold value defined as for a link request (ALE), then there is a beam forming and ALE monitoring according to the protocol of the ALE requestor, 413. It will be noted that, in the case where the communication is a fixed frequency, the procedure is similar with a listening done directly on the fixed frequency. The HUB control module checks whether the link request has been detected within a fixed delay (or timer), 414. If no link request has arrived within the fixed delay, then this request will not be satisfied 415 and the reception site will revert to a frequency listening or scanning phase.

In the case where a link request has arrived before the end of the timer (within the dedicated delay), 416, the control module at the reception level will check whether it is possible to establish a communication link. For that, it will interrogate the transmission site in order to check whether the latter has the necessary resources. If it is not possible to establish a communication link, then the reception site returns to the frequency scanning step. If the link can be established, the reception HUB module will establish this link by taking account of the information transmitted by the transmission site. Such information contains, for example, a response on the availability of the transmission resources for the frequency, the power and/or the direction requested. The switch to established link mode can then be done and the communication process can start, 417.

In parallel, the control module can also compute the direction of arrival (DOA) of the signal and transmit the information to the transmission site, 418. This information will be able to be used to determine the configuration available for a given direction more accurately. The reception control module can execute a recomputation every δt′ of the optimal beam without breaking the link, 419; the value of δf′ is chosen as a function of the application.

On the transmission site side 1, the transmission HUB control module computes, every ΔT, 420, an available configuration for each possible direction (as a function of the mission information, as a function of the current links, as a function of operator decisions, etc.), if the reception site has communicated direction of arrival information to it, it will also take this information into account. The computation of the configuration involves methods which will not be detailed because they are known to the person skilled in the art. The Tx resource availability information 421, and the information for the configuration are transmitted to the reception site. The transmission site starts the communication process, 422. Regularly, during the communication, the transmission site can check, 423, if there is a better suited configuration to meet the communication link requirement and, when a better configuration exists, the transmission site transmits a configuration adaptation command 424 to the communication equipment items 425; if necessary, that corresponds either to a modification of the mode of operation of the equipment items used for the communication, or to a partial or complete change of the equipment items, for example change of antenna or of power amplification.

According to one embodiment, the HUB control module on the transmission site side is adapted to collect information on the transmission/reception chains produced (established communications process) during missions to produce statistics on the use of certain frequencies, transmission power, frequency band, etc., and thus define the number of equipment items needed over the months, for fixed time periods, etc.

According to another variant embodiment, on detection of a priority link, the priority level being indicated in the signal received on the antennas (for example in a datum or a data field contained in the frame), the control module on the transmission side will be able to free up resources used by a current communication in favour of this priority link, Tx mechanism. It will execute this variant by using a pre-emption mechanism known to the person skilled in the art, for example by a release command to the HUB module, a “hung-up” command to the link controller.

Without departing from the scope of the invention, the HUB control module in reception could, on reception of a second link establishment request ALE, place a first current communication on hold, and do so over a time period t_{hold} chosen so as not to disrupt the first current link, in order to transmit, to the second party requesting link establishment, an acknowledgement of reception Ack_{request} of its ALE request and a message requesting renewal of its call; for example, “your call cannot be completed, we advise you to repeat your request later or to contact another station”.

According to another variant embodiment, the HUB control module in reception can discriminate several calls/communications on one and the same frequency with wide band reception on an array of antennas. It is then possible to launch several beam-forming processes (n<number of antennas−1) on each monitored frequency.

The system can also comprise a central system adapted to receive, from the transmission sites, information relating to communication requests that these transmission sites cannot take into account because of the excessive number of requests. In this case, the central system is capable of selecting another transmission site to satisfy a communication request. For example, it will be able to invoke one or more of the other transmission sites that it controls to ask them about their capacity to take on these communication requests that cannot be handled by the first system, and it will attribute the communication or communications to the transmission sites able to carry them out.

The system and the method which have just been described are used on already existing fixed infrastructures or can be implemented in infrastructures of reasonable dimensions, more mobile, easily deployable according to the needs of a given mission.

### Advantages

The method and the system according to the invention in particular allow the radio frequency means of one or more radio sites to be pooled and for them to be dynamically allocated to the local or remote users as a function of the services required.

This dynamic allocation optimizes the cost of acquisition and of operation of the network because the number of radios needed is computed as a function of the overall capacity required of the radio network and not of the number of users. This system can incorporate multi-vendor equipment items and therefore be possible to be freed of any dependency with respect to the radio suppliers.

1. A method for establishing a communication link for a mobile user in a high-frequency HF communication system comprising at least one transmission site and at least one reception site, the two sites being remote from one another by a distance D, comprising:
at the reception site, by using a wide band receiver, i.e. a listening band strictly greater than the instantaneous band of maximum possible modulated signals, scanning the signals or the frequencies, detecting whether there is a request to establish a communication link contained in the signals received on the receiver,
if yes, then transmit this request to establish a communication link to transmitters and to a control module HUB which checks if it possible to establish a communication link and if so who determines a possible configuration and establishes a communication mode for the mobile user based on configuration information calculated by the transmission site,
if no, then return to the scanning step of the received signals.

2. The method according to claim 1 comprising:
scanning the signals or the frequencies of interest fᵢₙₜ for a given communication, and estimating the energy level received on the frequencies monitored by the wide band receiver,
if the energy value received on the wide band receiver corresponds to a fixed frequency FF request or an automatic link establishment ALE request, then forming a beam for the communication, in the case where a link establishment request has been received before the expiry of a timer, checking whether the transmission site has resources for establishing the requested communication link and starting a communication mode, otherwise returning to the step of monitoring on the reception frequencies.

3. The method according to claim 1, wherein, for a fixed frequency FF request, the call is carried out on one and the same frequency.

4. The method according to claim 1, wherein, for an ALE request, the call is carried out successively or in parallel on several frequencies of different values.

5. The method according to claim 1, wherein the direction of arrival of the signal is computed and this information is transmitted to the transmission site to determine the transmission configuration available for a given configuration.

6. The method according to claim 1, wherein it comprises a step in which the computed configuration is compared with a set of existing configurations and, if a better configuration exists, then the HUB module transmits the new configuration parameters for the communication process or processes to the driven equipment items (amplifier, matrix, etc.).

7. The method according to claim 1, wherein it analyses the content of the communication request and, based on the priority of the communication, it frees up resources used by a current communication to reassign them to this new communication.

8. The method according to claim 1, wherein, on reception of a communication request, the method suspends a current communication to transmit a wait indication to the new communication.

9. An HF communication system comprising at least one transmission site and one reception site, the two sites being separated by a distance D chosen to avoid the disturbances from the transmission site on the reception site, wherein
the transmission site comprises at least several transmitters linked to a set of transmitting antennas, an HF control module,
the reception site comprises a wide band receiver and an HF control module,
said HF control modules at the transmission site and at the reception site are adapted to execute the steps of the method according to claim 1.
